(19) United States
(12) Patent Application Publication
(10) Pub. No.: US 2024/0217009 A1
(43) Pub. Date: Jul. 4, 2024

(54) HIGH FEED CIRCLE SEGMENT CUTTER

(71) Applicant: KYOCERA SGS PRECISION TOOLS, INC., Cuyahoga Falls, OH (US)

(72) Inventors: Brian R. HAMIL, Mogadore, OH (US); Jake RUTHERFORD, Cuyahoga Falls, OH (US)

(21) Appl. No.: 18/558,839

(22) PCT Filed: May 9, 2022
(86) PCT No.: PCT/US2022/072201

§ 371 Date: Nov. 3, 2023

Related U.S. Application Data
(60) Provisional application No. 63/185,718, filed on May 7, 2021.

(51) Int. Cl. B23C 5/10

(52) U.S. Cl. CPC B23C 5/1009; B23C 2210/0492; B23C 2210/082

(57) ABSTRACT

An end mill configured as a high feed circle segment cutter and a high feed end cutter utilizable in 5-Axis machining. The end mill comprises the end work of a high feed mill and the fluting of a circle segment cutter, thereby allowing the operator to rough out the bulk of the material with a high feed method (small axial and larger radial depths of cuts), then use the side of the tool to finish/semi-finish the walls of the part with the circle segment cutter geometry on the side of the tool.

### RELATED APPLICATIONS

This application claims priority benefit of U.S. Provisional Patent Application Ser. No. 63/185,718 filed May 7, 2021, entitled “High Feed Circle Segment Cutter,” the complete disclosure of which, in its entirety is herein incorporated by reference.

### BACKGROUND

Multiple tools are often utilized in 5-axis machining. This is time consuming and costly. Accordingly, a need exists for a single tool that is able to perform multiple functions.

### SUMMARY

A solid endmill that combines two tools commonly used together in 5-Axis machining, the high feed mill, and the circle segment cutter. Having the end work of a high feed mill and the fluting of a circle segment cutter. This will allow the user to rough out the bulk of the material with a high feed method (small axial and larger radial depths of cuts), then use the side of the tool to finish/semi-finish the walls of the part with the circle segment cutter geometry on the side of the tool.

In accordance with some aspects of the present disclosure a combination high feed mill circle segment cutting tool is described. A cutting tool includes a tool body having first end and a second end and a shank extending from the first end to a cutting portion located on the second end, the cutting portion including a high feed axial cutting face provided at a distal tip of the second end and a circle segment cutting portion extending from the high feed axial cutting face towards the shank. In a further embodiment, the shank is substantially cylindrical in shape defined by a shank diameter. In another further embodiment, the high feed axial cutting face is convex. In another further embodiment, the high feed axial cutting face comprises a plurality of teeth. In another further embodiment, the cutting tool further includes a plurality of flutes helically extending along the cutting portion, each of the flutes defining a circle segment cutting edge. In another further embodiment, the circle segment portion includes a curved cutting edge. In another further embodiment, each cutting edge is provided with a variable lead geometry. In another further embodiment, the cutting tool further includes and intermediate portion arranged between the shank portion and the cutting portion. In another further embodiment, the intermediate portion is cylindrical in shape having a second diameter. In another further embodiment, the second diameter is less than the first diameter. In another further embodiment, the cutting tool further includes a corner radius portion positioned between the circle segment-cutting portion and the high feed axial cutting face, wherein the corner radius portion is defined by a corner radius. In another further embodiment, a method of machining a work piece in a single pass using a combination circle segment and high feed axial cutting face. In another further embodiment, at least one cutting edge has a variable helix angle. In another further embodiment, the helix angle increases from the distal tip toward the shank.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, without departing from the scope of this disclosure.

FIG. 1 is an isometric view of a high feed circle segment cutter according to one or more embodiments.

FIG. 2 is a side view of the high feed circle segment cutter of FIG. 1.

FIG. 3 is an end view of the high feed circle segment cutter of FIGS. 1-2.

FIG. 4 is a side view of another high feed circle segment cutter according to one or more embodiments.

FIG. 5 is an end view of the high feed circle segment cutter of FIG. 4.

FIG. 6 is an isometric view of the high feed circle segment cutter of FIGS. 4 and 5.

FIG. 7 illustrates a cutting method utilizing the end mills of FIGS. 1-6.

### DETAILED DESCRIPTION

The present disclosure is related to end mill geometry and, more particularly, to end mills incorporating both circle segment (or barrel tool) geometry and high feed mill geometry.

As used herein, “shank” is the cylindrical (non-fluted) part of the tool which is used to hold and locate it in the tool holder. A shank may be perfectly round, and held by friction, or it may have a flat or ground feature that can be used to secure the tool via a mechanical method, e.g., via a setscrew. The diameter may be different from the diameter of the cutting part of the tool, so that it can be held by a standard tool holder. The length of the shank might also be available in different sizes.

The embodiments described herein provide an end mill that combines two separate tools commonly used together in 5-axis machining, the high feed mill and the circle segment cutter. Having the end work of a high feed mill and the fluting of a circle segment cutter. This will allow the user to rough out the bulk of the material with a high feed method (small axial and larger radial depths of cuts), then use the side of the tool to finish/semi-finish the walls of the part with the circle segment cutter geometry on the side of the tool.

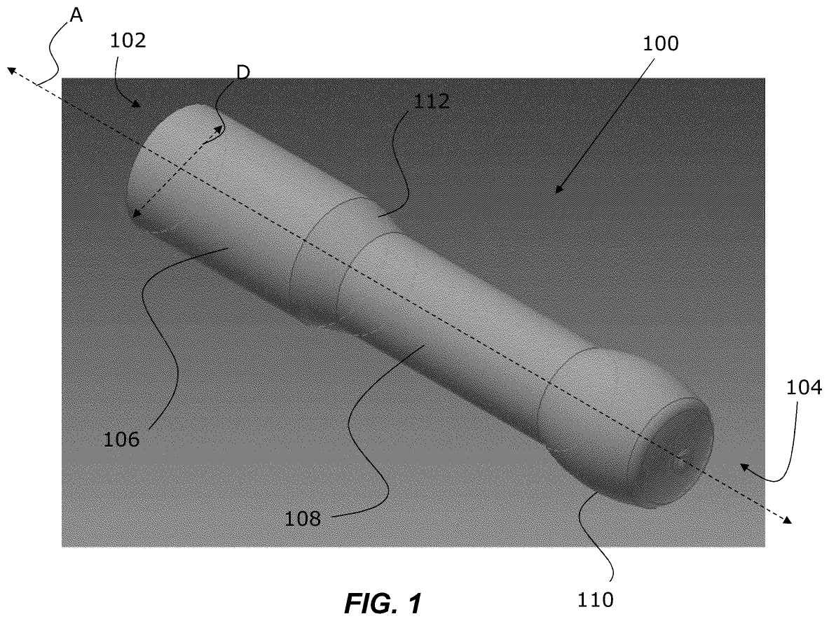

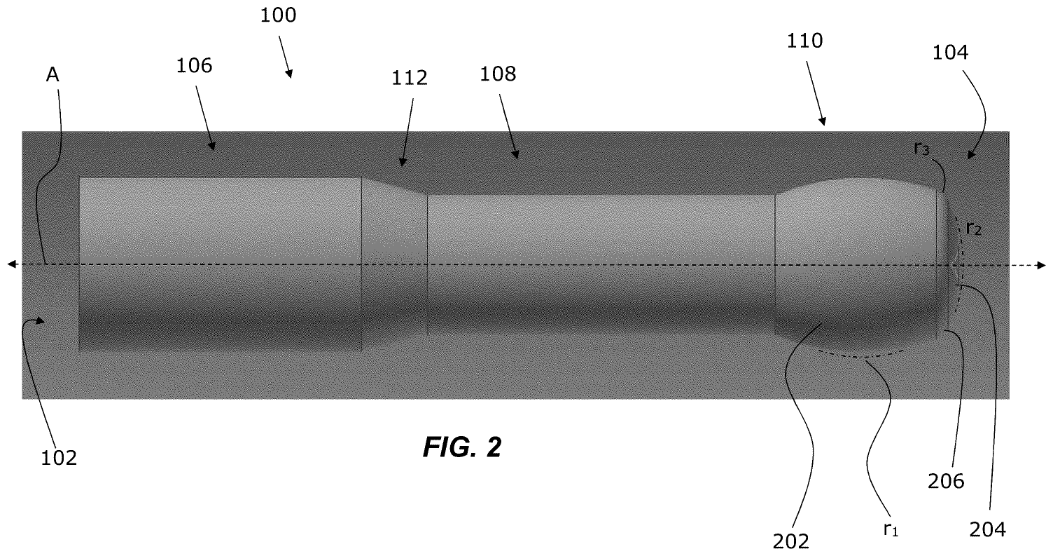

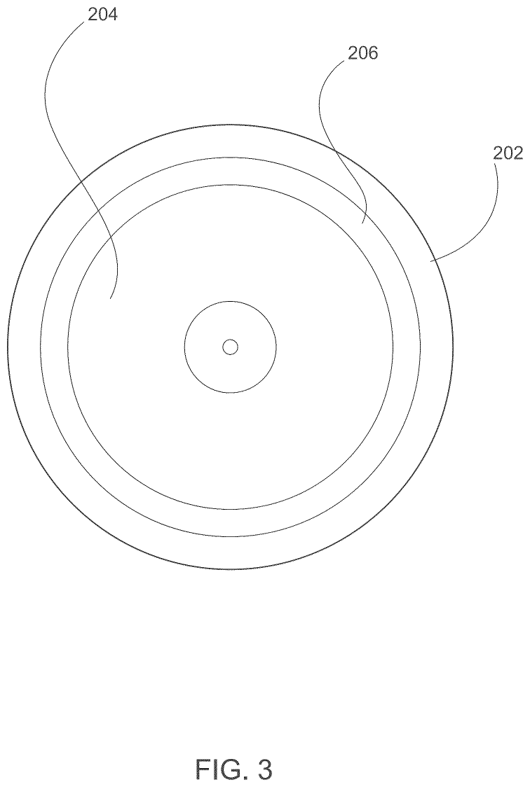

FIGS. 1-3 illustrate the general shape of end mill (or cutter) 100, according to one or more embodiments of the present disclosure. The end mill 100 is illustrated extending along an axis A, from a proximal end 102 thereof towards a distal end 104 thereof. The end mill 100 includes a shank portion 106 proximate to the proximal end 102, an intermediate portion 108 distally extending from the shank portion 106, and a cutting portion 110 extending distally from the intermediate portion 108. Thus, the intermediate portion 108 is arranged between the shank portion 106 and the cutting portion 110.

The shank portion 106 is illustrated as a cylindrical portion having a diameter D. The intermediate portion 108 may be of the same or different diameter. For example, in examples where they are of the same diameter, there may be a seamless or smooth transition from the shank portion 106 into the intermediate portion 108. In other examples, however, the diameter of the shank portion 106 and the intermediate portion 108 may be different. In the illustrated example, the diameter D of the shank portion 106 is larger than the diameter X of the intermediate portion 108. Here, a tapered transition portion 112 is arranged between the shank portion 106 and the intermediate portion 108, such that the tool diameter is gradually (e.g., linearly, convexly or concavely curved, etc.) reduced from the shank portion 106 into the intermediate portion 108. In some examples, however, the transition portion 112 is not included, such that the tool diameter steps down (or up) from the shank portion 106 diameter to the intermediate portion 108 diameter. It is to be appreciated that while a cylindrical shank 106 is illustrated, the shape of the shank 106 is not limiting and the shank may have other geometries or surface features configured to engage with an end mill machine.

The cutting portion 110 of the end mill 100 may include a combination of (or more than one) cutting geometries. In the illustrated example, the cutting portion 110 includes a circle segment-cutting portion 202 and a high feed mill axial cutting face 204. The high feed mill axial cutting face 204 provided at the distal tip 104 of the end mill 100.

Here, the cutting portion 202 is defined by a circle segment or arc portion having a radius r₁. The value of radius r₁ may vary depending on the ultimate end use application.

The axial cutting face 204 is a convex cutting face, defined by a radius r₂. The value of convex cutting surface radius r₂ may vary depending on the ultimate end use application. Utilization of the convex cutting surface radius r₂ on the distal end 104 of the end mill 100 changes the cutting forces during a milling/cutting operation so that load is pushed (axially) onto the spindle rather than radially onto the end mill 100 body. The radial loading may result in breaking, wearing, and/or failure of the end mill 100. Providing the axial cutting face 204 with a convex geometry may facilitate utilization of the end mill 100 in high feed applications. In addition, the cutting portion 202 may have a corner radius portion 206 between the circle segment-cutting portion 202 and the axial cutting face 204, where such corner radius portion 206 is defined by a corner radius r₃. The value of the corner radius r₃ may vary depending on the ultimate end use application.

Thus, the axial cutting face 204 is configured as an end face of a high feed mill, which thereby allows the user to rough out the bulk of the material with a high feed method (i.e., small axial and larger radial depths of cuts), and the circle segment cutting portion 202 includes fluting of a circle segment cutter, such that the user may then use the side of the end mill 100 to finish/semi-finish the walls of the machined part with the circle segment cutter geometry on the side of the tool.

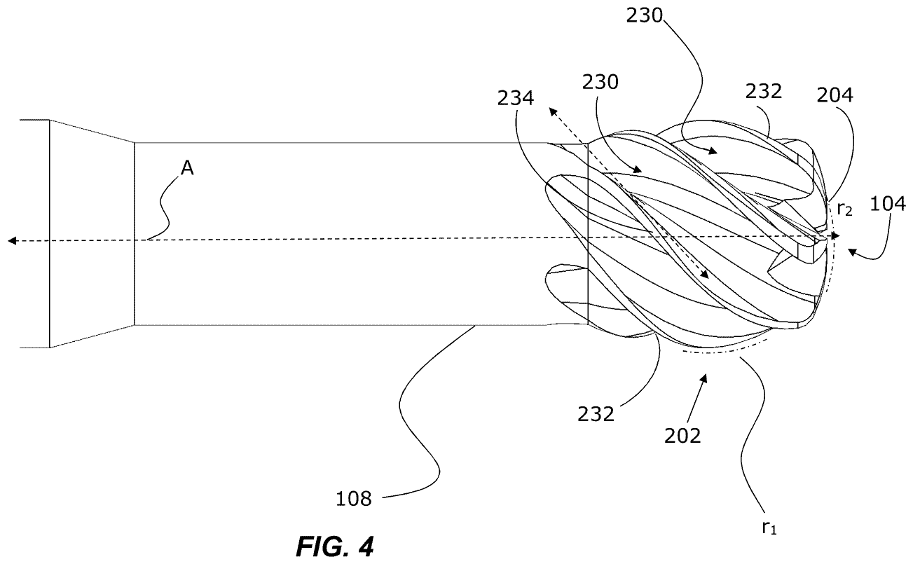

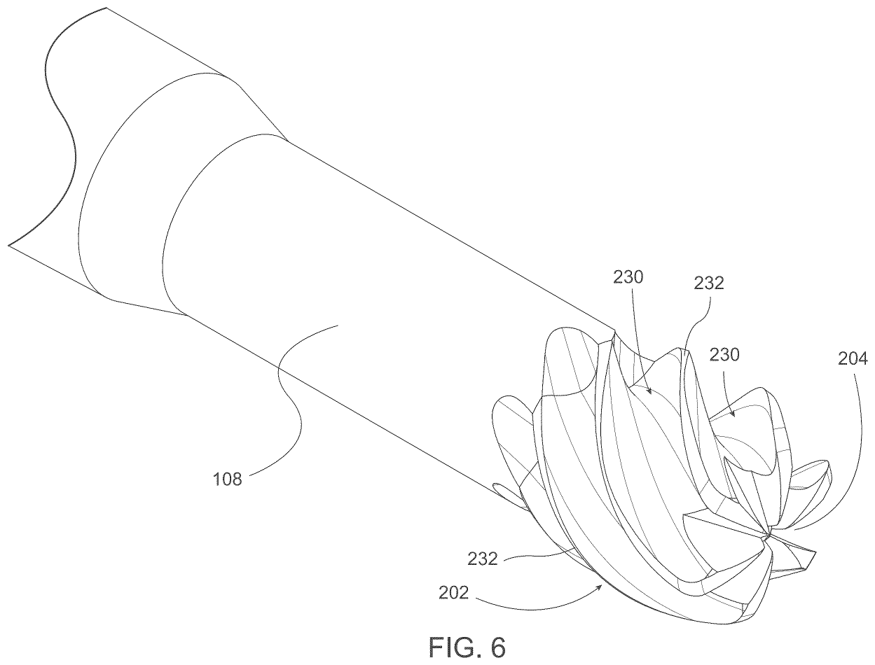

FIGS. 4-6 illustrate another exemplary embodiment of an end mill 400 having both circle segment (or barrel tool) geometry and high feed mill geometry. It is to be appreciated that the end mill tool 400 includes features similar to end mill 100 and best understood with reference thereto. That is, the end mill 400 as illustrated includes a shank portion 106 proximate to the proximal end 102, an intermediate portion 108 distally extending from the shank portion 106, and a cutting portion 110 extending distally from the intermediate portion 108. Thus, the intermediate portion 108 is arranged between the shank portion 106 and the cutting portion 110.

The illustrated embodiment of FIGS. 4-6 includes circle-cutting portion 202 with a plurality of flutes 230 and cutting edges 232 arranged at one or more helix angles 234. In some embodiments, the end mill 400 includes six flutes but it may instead include more or less than six flutes. In other embodiments, the end mill includes five flutes. Regardless of number, the flutes may be uniformly evenly arranged about the central axis or the flutes may instead be configured with an unequal indexing.

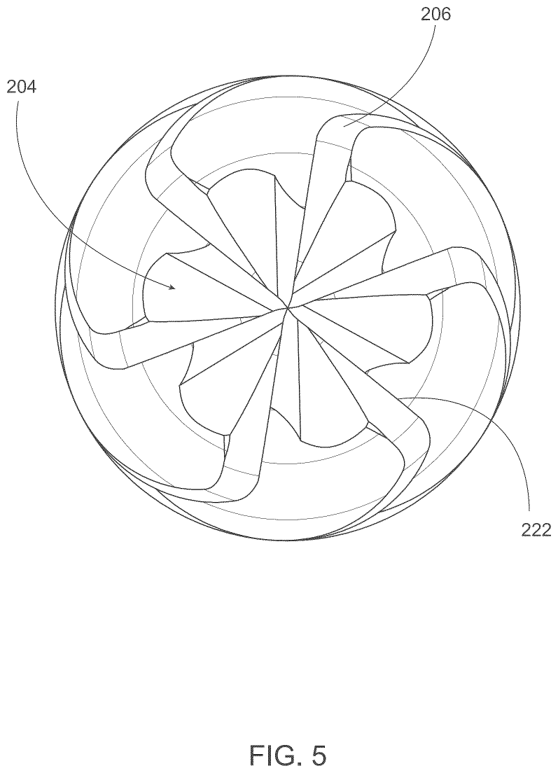

The tool 400 also includes a plurality of peripheral cutting edges 232 extending radially projecting from the central axis A and extending helically around the central axis. In the illustrated example, each cutting edge 232 is provided with a constant helix angle geometry (i.e., the helix angle 234 remains constant when evaluated from the distal end 104 towards the proximal end 102 (as illustrated in FIG. 5). The helix angle 234 of a tool is measured by the angle formed between the centerline of the tool (Axis A) and a straight-line tangent along the cutting edge. The helix angle controls the angle of the cutting edge entering the work piece. The helix angle can contribute to chip control by evacuating the chips at particular angles. For example, a higher helix angle can eject chips at a steeper angle. Control of the helix angle can also relate to tool pressure, the finish of the cutting surface, and heat control.

In the illustrated example, each cutting edge 232 is provided with a variable lead (pitch) geometry (constant helix angle 234). While a constant helix angle is shown in the figures, it is to be appreciated that each cutting edge may instead be provided with a variable helix angle geometry. That is, each lead may instead be provided with a constant lead (pitch) geometry, for example, where each cutting edge is provided with a variable helix angle geometry.

In some embodiments, each of the cutting edges includes the same helix angle 234, whereas, in other embodiments, one or more of the cutting edges may include a different helix angle relative to the helix angles of one or more of the other cutting edges.

In some embodiments, the helix angle 234 increases from the distal end toward the shank 108. This is also referred to as a constant lead (or constant pitch i.e., the degree of radial separation between the cutting edges at a given point along the length of cut) tool. The term “constant lead” means that for every degree of rotation, the linear travel/length of the cutting edge/tooth is the same no matter from where you measure such travel. One or more teeth/cutting edges may have the same or different constant lead. Thus, the radial separation between cutting edges of the tool remains constant along the length of cut.

The axial cutting face 204 includes axial teeth 222, i.e., cutting edges at the distal end 104 of the mill tool and end gashes, the pockets on the distal end of the end mill that create the axial teeth. In the illustrated embodiment of FIGS. 4-6, six axial teeth 222 are shown. However, it is to be appreciated that the number of axial teeth of the axial cutting face is not limiting and that more or less may be includes.

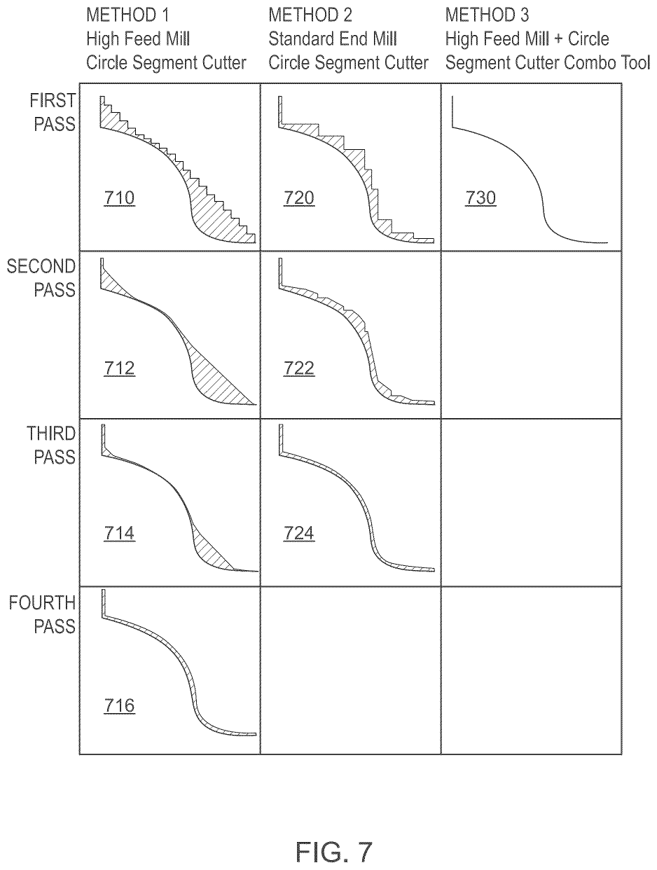

FIG. 7 illustrates a method 700 utilizing the end mill 100, 400 according to one or more embodiments of the present disclosure. In particular, the method 700 utilizing tools described herein provide efficiencies. For example, the method 700 reduces down machining time as it incorporates less/fewer machining passes than as would other machine methods using other tools, such as methods 702, 704 (i.e., METHOD 1 and METHOD 2).

Methods using traditional high feed tools such as method 702 cannot perform straight wall cuts, and must cut several steps into the work pieces during one or more roughing steps. Thereafter, the work piece may be subject to a semi-finishing pass before it is subject to bench finishing. Thus, the method 702 utilizes a first pass/cut 710 using a high feed mill, which generally cuts axially rather than radially, to form a stair step type cut in the work piece as shown in cell 710. Then, the high feed tool/cutter may be removed and replaced with a circle segment cutter, and such circle segment cutter may then be utilized for subsequent passes. Here, for example, the circle segment cutter (and/or ball nose) is used for a second pass shown in cell 712 to shape contour, but such cutter may be limited by the depth of cut at which it may engage the work piece. Thus, the same cutter (or a different cutter swapped after removing the prior cutter, e.g., a larger tool could be used in the second pass 712) may take a third pass shown in cell 714 to further rough out the material as desired. Finally, a fourth pass shown in cell 716 may be taken with the circle segment cutter (and/or ball nose) to semi-finish the cutwork piece. Thereafter, the work piece will be taken to the bench for finishing (not illustrated in FIG. 7).

The second method 704 illustrates a milling sequence using a standard end mill and then a circle segment cutter (and/or ball nose). Here, a first pass shown in cell 720 is performed using the standard end mill. Such first pass may comprise standard rouging passes to step down the material of the work piece into a shape more representative of the final form/contour to be cut. Then, the standard end mill may be removed and replaced with a circle segment cutter, and such circle segment cutter may then be utilized for subsequent passes. Here, for example, the circle segment cutter is used for a second pass shown in cell 722 to remove additional material in a manner that the work piece more closely resembles the ultimately desired shape contour of the work piece. Finally, a third pass shown in cell 724 may be taken with the circle segment cutter to semi-finish the cutwork piece. Thereafter, the work piece will be taken to the bench for finishing (not illustrated in FIG. 7).

However, the presently disclosed work piece may shape the work pieces with the desired contour with a single pass shown in cell 730, and without utilizing other tooling to roughen and semi-finish. Thus, machine time is reduced due to utilization of a single tool (i.e., the high feed rate circle segment cutter 100, 400). Here, the tool is stepped down pass by pass to the ultimate contour/shaped desired to be cut into the work piece.

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

The terms “proximal” and “distal” are defined herein relative to a tool operator or CNC machine having an interface configured to mechanically couple a tool to a spindle. The term “proximal” refers to the position of an element closer to the operator or CNC machine and the term “distal” refers to the position of an element further away from the operator or CNC machine. Moreover, the use of directional terms such as above, below, upper, lower, upward, downward, left, right, and the like are used in relation to the illustrative embodiments as they are depicted in the figures, the upward or upper direction being toward the top of the corresponding figure and the downward or lower direction being toward the bottom of the corresponding figure.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Please amend the first paragraph in the claims as follows:

1. A cutting tool comprising:
a tool body having first end and a second end;
a shank extending from the first end to a cutting portion located on the second end, the cutting portion including a high feed axial cutting face provided at a distal tip of the second end and a circle segment-cutting portion extending from the high feed axial cutting face towards the shank.

2. The cutting tool according to claim 1, wherein the shank is cylindrical in shape defined by a shank diameter.

3. The cutting tool according to claim 1, wherein the high feed axial cutting face is convex.

4. The cutting tool according to claim 1, wherein the high feed axial cutting face comprises a plurality of teeth.

5. The cutting tool according to claim 1, further comprising a plurality of flutes helically extending along the cutting portion, each of the flutes defining a circle segment cutting edge.

6. The cutting tool according to claim 1, wherein circle segment portion includes a curved cutting edge.

7. The cutting tool according to claim 6, wherein each cutting edge is provided with a variable lead geometry.

8. The cutting tool according to claim 1 further comprising an intermediate portion arranged between the shank portion and the cutting portion.

9. The cutting tool according to claim 8, wherein the intermediate portion is cylindrical in shape having a second diameter.

10. The cutting tool according to claim 9, wherein the second diameter is less than the shank diameter.

11. The cutting tool according to claim 1 further comprising a corner radius portion positioned between the circle segment cutting portion and the high feed axial cutting face, wherein the corner radius portion is defined by a corner radius.

12. The cutting tool according to claim 1, wherein at least one cutting edge has a variable helix angle.

13. The cutting tool according to claim 12, wherein the helix angle increases from the distal tip toward the shank.

14. (canceled)
